(19) United States
(12) Patent Application Publication
(10) Pub. No.: US 2006/0152486 A1
(43) Pub. Date: Jul. 13, 2006

(54) MOTION-CONTROLLED PORTABLE ELECTRONIC DEVICE

(76) Inventor: Chih-Hsien Wei, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/908,468

(22) Filed: May 12, 2005

(30) Foreign Application Priority Data
Jan. 13, 2005 (TW) 094100996

(51) Int. Cl. G09G 5/08

(52) U.S. Cl. 345/158

(57) ABSTRACT

A motion-controlled portable electronic device includes a motion sensor for detecting a position shift and a direction of motion of the portable electronic device; a display device for displaying a cursor; and a microprocessor electrically connected to the motion sensor, and the display device for driving the display device according to the position shift and the direction of motion to adjust a position of the cursor on the display device.

### BACKGROUND OF INVENTION

1. Field of the Invention

The present invention relates to a motion-controlled portable electronic device, and more specifically, to a portable electronic device integrated with an optical mouse sensor for controlling the display position of a cursor.

2. Description of the Prior Art

Due to the rapid improvement in related technology, more and more digital products are now miniaturized and integrated to increase the convenience of daily life, for example, mobile phones, personal digital assistants (PDAs), smart phones, and MP3 players. These products have many integrated functions, so they all have a display device (ex: a liquid crystal display, LCD) showing messages and selections, enabling them to be used easily. The method of operation can be utilizing buttons to control the moving direction of a cursor, used by mobile phones and MP3 players. Alternatively, users can control the movement of a cursor by clicking a touch screen through a touch pen, used by PDAs and smart phones.

Such control methods as described above have advantages and disadvantages, but it is obviously that these well-known methods of cursor control are different from the cursor control method of digital products with which users are most familiar, i.e. computers. In a computer system, users generally control a cursor through using a mouse. Therefore, users are unaccustomed to other methods of cursor control and may need to spend unnecessary time on studying new control devices such as buttons or touch pens.

### SUMMARY OF INVENTION

The claimed invention is to provide a portable electronic device integrated with an optical mouse sensor for conveniently controlling the cursor position on the display device of a portable electronic device to solve the above-mentioned problems.

According to an embodiment of the claimed invention, a motion-controlled portable electronic device is disclosed. The portable electronic device includes a motion sensor for detecting a position shift and a moving direction of the portable electronic device, a display device for displaying a cursor, and a microprocessor electrically connected to the motion sensor and to the display device for driving the display device according to the position shift and the direction of motion to adjust a position of the cursor on the display device.

The motion-controlled portable electronic device in the claimed invention includes a motion sensor (ex: an optical mouse sensor), therefore, while the portable electronic device is moving, the motion sensor provides data concerning the position shift and the direction of motion for a microprocessor in the portable electronic device. Next, according to the data, the microprocessor further adjusts the cursor position on the display device of the portable electronic device. In other words, the method for controlling a cursor of a motion-controlled portable electronic device in the claimed invention is similar to the method for controlling a cursor on a computer monitor utilizing a mouse.

The present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a mobile phone according to a first embodiment of the present invention.

FIG. 2 is a rear view of the mobile phone shown in FIG. 1.

FIG. 3 is a block diagram of the mobile phone shown in FIG. 1.

FIG. 4 is a diagram of a PDA according to a second embodiment of the present invention.

FIG. 5 is a rear view of the PDA shown in FIG. 4.

### DETAILED DESCRIPTION

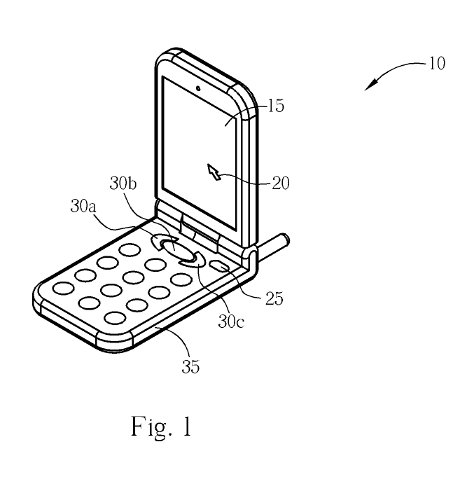

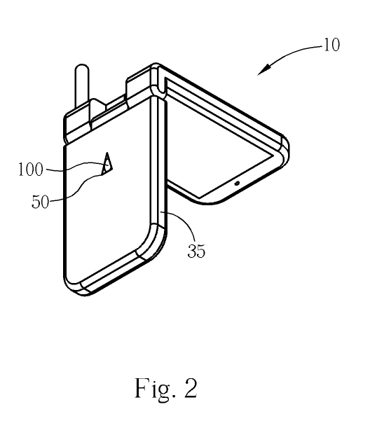

Please refer to FIG. 1 and FIG. 2. FIG. 1 is a diagram of a mobile phone 10 according to a first embodiment of the present invention, and FIG. 2 is a rear view of the mobile phone 10 shown in FIG. 1. In order to describe features of the claimed invention clearly, only devices related to the claimed invention in the mobile phone 10 will be discussed and illustrated in the following disclosure. As shown in FIG. 1, the display device 15 is an LCD panel, or another kind of panel such as an organic-light-emitting-diode panel, or an advanced display panel (ex: a field emission display (FED), or a plasma display panel (PDP)), showing messages and various objects (ex: a list of selections) selected by users. As with general computer monitors, the display device 15 displays a movable cursor 20, which is controlled by users to select objects shown on the display device 15. The mobile phone 10 has a housing 35 and a number of buttons 30a, 30b, and 30c, which are positioned on the housing 35. Users are allowed to set functions of the buttons 30a, 30b, and 30c by themselves via the operation interface of the mobile phone 10, or accept a default value set by producers making the button functions the same as general computer mice buttons. Users click the buttons 30a, 30b, and 30c to select, when the cursor 20 is positioned on an object required by the users on the display device 15. Please note that, in this embodiment, there is a button 25 on the housing 35, and the button 25 is a control module for switching between the control method of traditional mobile phones and the method disclosed in the claimed invention. In other words, users have discretion to switch the button 25 according to the condition and users' habits to choosing a suitable control method. As FIG. 2 shows, the housing 35 has an opening 50, and an optical mouse sensor 100 is assembled in the housing 35. The optical mouse sensor 100 outputs and receives a light beam through the opening 50 to detect the position shift and moving direction of the mobile phone 10. A detailed description is as follows.

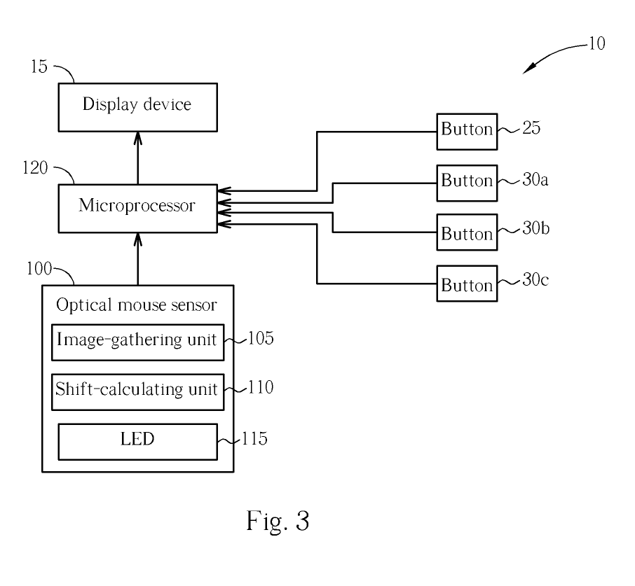

Please refer to FIG. 1 and FIG. 3. FIG. 3 is a block diagram of the mobile phone 10 shown in FIG. 1. In the embodiment, the optical mouse sensor 100 includes an image-gathering unit 105, a shift-calculating unit 110, and a light emitting diode (LED) 115. The LED 115 outputs a light beam as a light source when the mobile phone 10 is switched to operate the control method disclosed in the claimed invention. When the mobile phone 10 moves on a nontransparent surface (ex: a nontransparent table), the light emitted from the LED 115 is reflected by the nontransparent surface and gathered by the image-gathering unit 105 to form images at different times. Next, the shift-calculating unit 110 compares the images gathered at different time to continuously calculate the position shift and the moving direction of the mobile phone 10. Continuously, the optical mouse sensor 100 transmits the data (position shift and direction of motion) to a microprocessor 120, and the microprocessor 120 drives the display device 15 according to the position shift and the direction of motion to adjust the position of the cursor 20 on the screen. Additionally, control signals outputted by buttons 25, 30a, 30b, and 30c are also transmitted to the microprocessor 120 to control actions of the mobile phone 10.

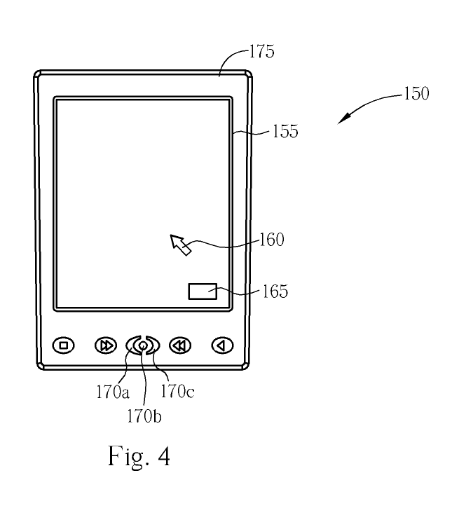

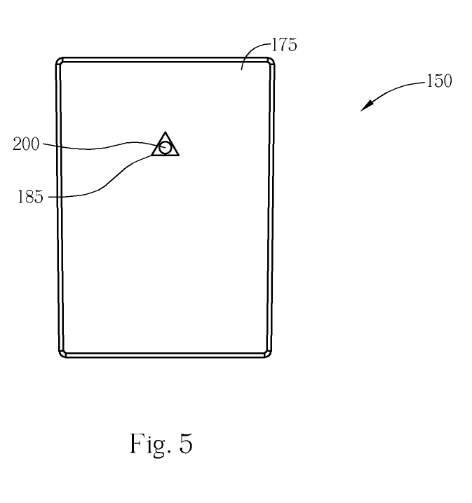

Please refer to FIG. 4 and FIG. 5. FIG. 4 is a diagram of a PDA 150 according to a second embodiment of the present invention, and FIG. 5 is a rear view of the PDA 150 shown in FIG. 4. In this embodiment, the PDA 150 includes a display device 155, a plurality of buttons 170a, 170b, and 170c, and a housing 175. The cursor-controlling method of the PDA 150, according to a second embodiment of the present invention, is similar to the cursor-controlling method of the mobile phone 10 described in the first embodiment, and devices in this embodiment having the same name as in the first embodiment have similar (or the same) functions and rules, therefore, a detailed description is not repeated. As shown in FIG. 4, the display device 155 displays a cursor 160 and an icon 165. The display device 155 can be a touch screen for showing messages and various items selected by users, and users can use a touch pen (not illustrated) for generating a control signal via the display device 155. The buttons 170a, 170b, and 170c positioned on the housing 175 of the PDA 150 are for generating control signals. For example, users are allowed to click the button 170a for selection, when the cursor 160 is positioned on a predetermined region of the display device 155. In the embodiment, a cursor-controlling method switched by software is disclosed. It is well-known that in a common PDA, a touch screen is used as a display device, and users utilize a touch pen clicking the touch screen to select an object. In this embodiment, therefore, the touch screen is chosen to be a control module, where the touch screen displays an icon 165 in the corner. As a result, users can control whether the PDA 150 is switched to the control method disclosed in the claimed invention by clicking the icon 165 through using a touch pen. If the control method disclosed in the claimed invention is chosen, the optical mouse sensor 200 positioned in the PDA 150 starts to detect a position shift and a direction of motion of the PDA 150 through an opening 185. Therefore, as mentioned above, this data is applied to drive the display device 155 to adjust the position of the cursor 160 on the touch screen.

Please note that the first embodiment uses a mobile phone 10 as an example to explain how the present invention controls a cursor 20, and the second embodiment uses a PDA 150 as an example to explain how the present invention controls a cursor 160. However, the motion-controlled portable electronic device claimed in the present invention is not only bounded in mobile phones and PDAs. For instance, smart phones or MP3 players can also use the method of the claimed invention.

Compared with the prior art, by means of installing a motion sensor (ex: an optical mouse sensor) in the portable electronic device and making some suitable modifications to the related software and hardware, users can conveniently control the cursor on the display device of a portable electronic device. Users use the method for controlling a computer mouse, and do not need to spend time on getting used to a new control method. In conclusion, the method of controlling a cursor of a motion-controlled portable electronic device in the claimed invention has significant advantages over the related art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motion-controlled portable electronic device, comprising:
a motion sensor for detecting a position shift and a direction of motion of the portable electronic device;
a display device for displaying a cursor; and
a microprocessor electrically connected to the motion sensor and to the display device for driving the display device according to the position shift and the direction of motion to adjust a position of the cursor on the display device.

2. The portable electronic device of claim 1, further comprising a housing, where the motion sensor is an optical motion sensor positioned in the housing.

3. The portable electronic device of claim 2, wherein the optical motion sensor comprises:
an image-gathering unit for gathering a plurality of images at different time; and
a shift-calculating unit electrically connected to the image-gathering unit for comparing the plurality of images to calculate the position shift and the direction of motion.

4. The portable electronic device of claim 3, wherein the optical motion sensor further comprises a light source.

5. The portable electronic device of claim 4, wherein the light source is a light emitting diode (LED).

6. The portable electronic device of claim 4, wherein the optical motion sensor is an optical mouse sensor.

7. The portable electronic device of claim 1, further comprising:
a control module electrically connected to the microprocessor for generating a control signal to the microprocessor to determine whether to utilize the motion sensor to control the cursor or not.

8. The portable electronic device of claim 7, wherein the control module is a button, and the button triggers the control signal when the button is pressed.

9. The portable electronic device of claim 7, wherein the control module is a touch screen, and the touch screen triggers the control signal when a predetermined region on the touch screen is clicked.

10. The portable electronic device of claim 1, wherein the portable electronic device is a mobile phone, a personal digital assistant (PDA), a smart phone, or an MP3 player.
